(19) United States
(12) Patent Application Publication
(10) Pub. No.: US 2016/0041634 A1
(43) Pub. Date: Feb. 11, 2016

(54) SELF-POWERED WIRELESS MOUSE APPARATUS

(71) Applicant: Creative Sensor Inc., Taipei City (TW)

(72) Inventors: Jen-Chun WENG, Taipei City (TW); Lun WANG, Taipei City (TW)

(21) Appl. No.: 14/456,290

(22) Filed: Aug. 11, 2014

(51) Int. Cl. G06F 3/0354; G09G 5/00

(52) U.S. Cl. CPC G06F 3/03543; G09G 5/003; G09G 2330/021

(57) ABSTRACT

A self-powered wireless mouse apparatus includes a mouse wheel module and a back-end processing module. The mouse wheel module includes a mouse wheel, a stator plate, a plurality of coils and a rotation shaft. The mouse wheel includes a multipolar magnetic body. The coils are arranged on the stator plates. The rotation shaft is connected to the mouse wheel and the stator plate. The back-end processing module includes an alternating current to direct current conversion circuit and an energy storing apparatus. The multipolar magnetic body is driven so that the coils generate induced alternating current voltages when the mouse wheel is rotated. The alternating current to direct current conversion circuit converts the induced alternating current voltages of the coils into direct current voltages and then stores the direct current voltages in the energy storing apparatus to supply power to the self-powered wireless mouse apparatus.

### BACKGROUND OF THE INVENTION

1. Field of the Invention

The present invention relates to a wireless mouse apparatus, and especially relates to a self-powered wireless mouse apparatus.

2. Description of the Related Art

A mouse is a very common electronic apparatus. The mouse can control a screen cursor or a screen scroll. Therefore, the mouse is very important for using a computer.

A wireless mouse needs battery power. The wireless mouse cannot be used when the battery power is low. It is very inconvenient.

Moreover, the mouse can control the screen scroll when a wheel of the mouse is rotated. Currently, the mouse comprises an encoder. The encoder is connected to the wheel of the mouse. By the encoder, the screen scroll is moved upward when the wheel of the mouse is rotated forward. By the encoder, the screen scroll is moved downward when the wheel of the mouse is rotated backward.

### SUMMARY OF THE INVENTION

In order to solve the above-mentioned problems, an object of the present invention is to provide a self-powered wireless mouse apparatus.

In order to achieve the object of the present invention mentioned above, the self-powered wireless mouse apparatus comprises a mouse wheel module and a back-end processing module.

The back-end processing module is electrically connected to the mouse wheel module. The mouse wheel module comprises a mouse wheel, at lease a stator plate, a plurality of coils and a rotation shaft. The mouse wheel comprises a multipolar magnetic body. The coils are arranged on the stator plate. The rotation shaft is connected to the mouse wheel and the stator plate, so that the mouse wheel is rotated opposite to the stator plate. Therefore, the coils generate induced alternating current voltages. The back-end processing module comprises an alternating current to direct current conversion circuit and an energy storing apparatus. The alternating current to direct current conversion circuit is electrically connected to the coils. The energy storing apparatus is electrically connected to the alternating current to direct current conversion circuit. The multipolar magnetic body is driven so that the coils generate the induced alternating current voltages when the mouse wheel is rotated. The alternating current to direct current conversion circuit converts the induced alternating current voltages of the coils into direct current voltages and then stores the direct current voltages in the energy storing apparatus to supply power to the self-powered wireless mouse apparatus.

Moreover, the self-powered wireless mouse apparatus comprises two stator plates. The mouse wheel is arranged at a midpoint between the stator plates. The stator plates are arranged symmetrically.

Moreover, the mouse wheel further comprises a mouse wheel hole defined at a center of the multipolar magnetic body. The stator plate comprises a stator plate hole defined at a center of the stator plate. The rotation shaft is through the mouse wheel hole and the stator plate holes.

Moreover, the coils are arranged evenly and symmetrically on the stator plates.

Moreover, a quantity of the coils is, for example but not limited to, an integer multiple of a quantity of magnetic poles of the multipolar magnetic body.

Moreover, the multipolar magnetic body is a cylinder.

Moreover, the magnetic poles of the multipolar magnetic body are arranged evenly.

Moreover, the coils face the mouse wheel.

Moreover, the self-powered wireless mouse apparatus further comprises a mouse base. The stator plates are arranged on the mouse base.

Moreover, the mouse base comprises two support columns for supporting the stator plates.

The efficiency of the present invention is to provide a self-powered wireless mouse apparatus.

### BRIEF DESCRIPTION OF DRAWING

FIG. 1 shows a top view of the self-powered wireless mouse apparatus of the present invention.

FIG. 2 shows a partial assembly drawing of the self-powered wireless mouse apparatus of the present invention.

FIG. 3 shows a partially exploded view of the self-powered wireless mouse apparatus of the present invention.

FIG. 4 shows an embodiment of the magnetic poles on one side of the multipolar magnetic body of the present invention.

FIG. 5 shows the magnetic poles on the other side of the multipolar magnetic body of FIG. 4.

FIG. 6 shows an embodiment of the phase difference of the induced electromotive forces of the coils of the present invention.

FIG. 7 shows a top view of another embodiment of the self-powered wireless mouse apparatus of the present invention.

FIG. 8 shows a partial assembly drawing of another embodiment of the self-powered wireless mouse apparatus of the present invention.

FIG. 9 shows a partial exploded view of another embodiment of the self-powered wireless mouse apparatus of the present invention.

### DETAILED DESCRIPTION OF THE INVENTION

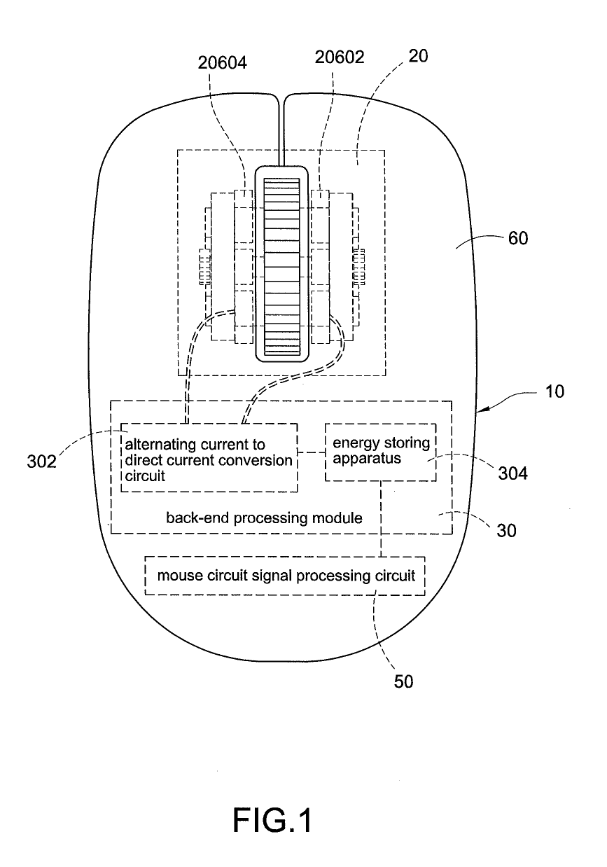

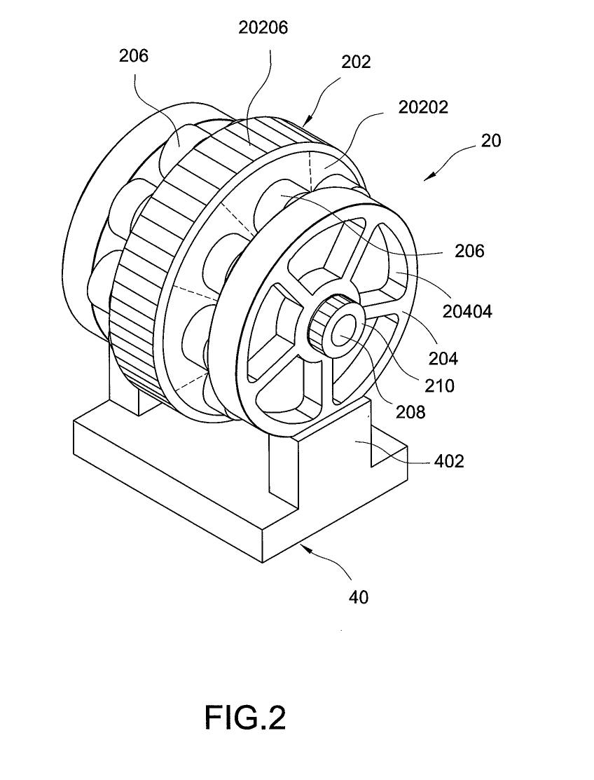

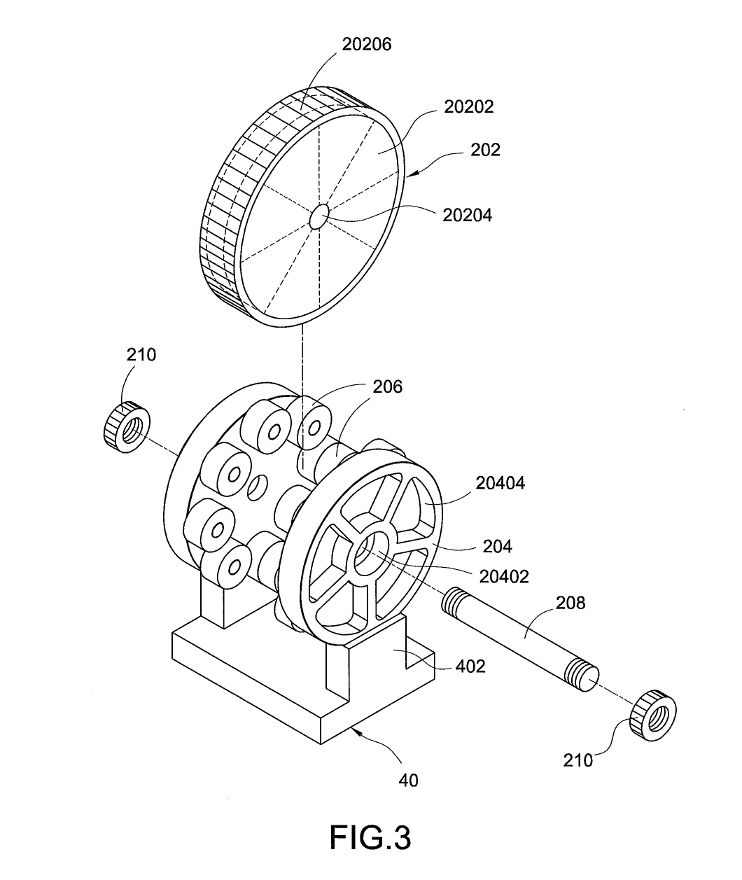

FIG. 1 shows a top view of the self-powered wireless mouse apparatus of the present invention. FIG. 2 shows a partial assembly drawing of the self-powered wireless mouse apparatus of the present invention. FIG. 3 shows a partially exploded view of the self-powered wireless mouse apparatus of the present invention.

A self-powered wireless mouse apparatus 10 comprises a mouse wheel module 20, a back-end processing module 30, a mouse base 40, a mouse circuit signal processing circuit 50 and a mouse upper cover body 60.

The mouse wheel module 20 comprises a mouse wheel 202, two stator plates 204, a plurality of coils 206, a rotation shaft 208 and two nuts 210. The back-end processing module 30 comprises an alternating current to direct current conversion circuit 302 and an energy storing apparatus 304. The mouse base 40 comprises two support columns 402.

The mouse wheel 202 comprises a multipolar magnetic body 20202, a mouse wheel hole 20204 and a side cover body 20206. The stator plate 204 comprises a stator plate hole 20402 and at least a hollow part 20404.

The mouse wheel 202 is, for example but not limited to, a cylinder. The multipolar magnetic body 20202 is, for example but not limited to, a cylinder. The side cover body 20206 covers a side of the multipolar magnetic body 20202. The mouse wheel hole 20204 is defined at a center of the multipolar magnetic body 20202 (namely, a center of a circle).

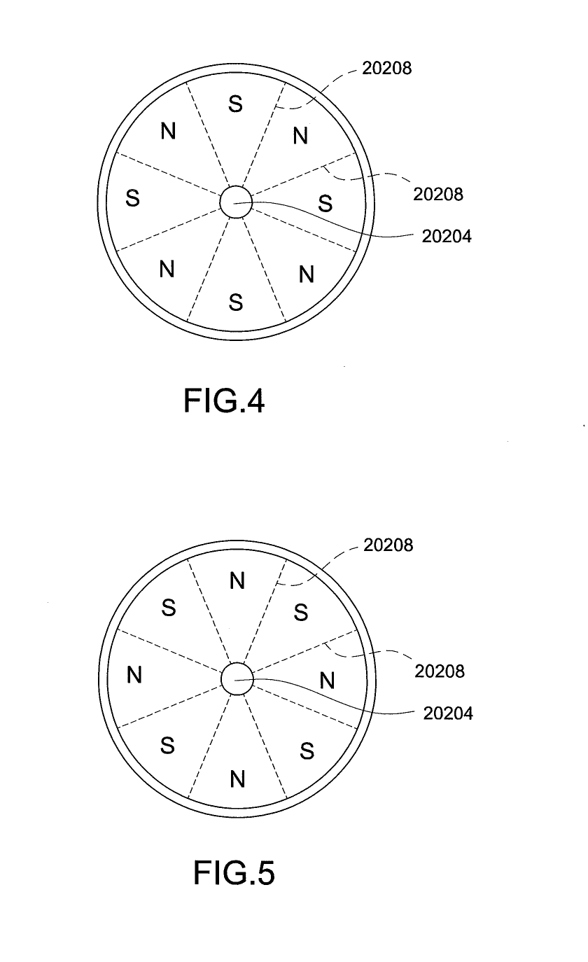

FIG. 4 shows an embodiment of the magnetic poles on one side of the multipolar magnetic body of the present invention. FIG. 5 shows the magnetic poles on the other side of the multipolar magnetic body of FIG. 4. An S pole is adjacent to two N poles, and the other side of the multipolar magnetic body 20202 is an N pole. An N pole is adjacent to two S poles, and the other side of the multipolar magnetic body 20202 is an S pole.

A quantity of the coils 206 is, for example but not limited to, an integer multiple of a quantity of magnetic poles of the multipolar magnetic body 20202. The quantity of the magnetic poles of the multipolar magnetic body 20202 is eight as shown in FIG. 4 and FIG. 5. The quantity of the coils 206 is sixteen as shown in FIG. 2 and FIG. 3.

As shown in FIG. 4 and FIG. 5, at least a cutting line 20208 cuts the center of the circle of the bottom side of the multipolar magnetic body 20202 (namely, the mouse wheel hole 20204), so that the magnetic poles of the multipolar magnetic body 20202 are defined. The magnetic poles of the multipolar magnetic body 20202 are arranged evenly. In another word, angles (intersection angles) formed by the cutting line(s) 20208, which cut the center of the circle of the bottom side of the multipolar magnetic body 20202 (namely, the mouse wheel hole 20204), are equal. For example, as shown in FIG. 4 and FIG. 5, each of the intersection angles is 45 degrees.

The stator plate 204 is, for example but not limited to, a cylinder. The stator plate hole 20402 is defined at a center of the stator plate 204 (namely, a center of a circle). The hollow part 20404 is used to hollow the stator plate 204 to reduce the weight and the cost of the stator plate 204.

The stator plates 204 are arranged on the mouse base 40. The support columns 402 are used for supporting the stator plates 204.

The stator plates 204 are parallel to each other. The stator plates 204 are arranged symmetrically. The mouse wheel 202 is arranged at a midpoint between the stator plates 204. The mouse wheel 202 is parallel to the stator plates 204.

The rotation shaft 208 is a straight rod. The rotation shaft 208 is through the mouse wheel hole 20204 and the stator plate holes 20402. In another word, the rotation shaft 208 is connected to the mouse wheel 202 and the stator plates 204, so that the mouse wheel 202 is rotated opposite to the stator plates 204. Therefore, the coils 206 generate induced alternating current voltages. The nuts 210 are arranged at two terminals of the rotation shaft 208.

The coils 206 are arranged on the stator plates 204. In an embodiment, the coils 206 are arranged evenly and symmetrically on the stator plates 204. The coils 206 face the mouse wheel 202. For example, in an embodiment, each of the coils 206 faces different magnetic pole of the multipolar magnetic body 20202.

The back-end processing module 30 is electrically connected to the mouse wheel module 20. The alternating current to direct current conversion circuit 302 is electrically connected to the coils 208. The energy storing apparatus 304 is electrically connected to the alternating current to direct current conversion circuit 302. The mouse circuit signal processing circuit 50 is electrically connected to the energy storing apparatus 304.

The mouse upper cover body 60 covers the mouse wheel module 20, the back-end processing module 30, the mouse base 40 and the mouse circuit signal processing circuit 50 except the mouse wheel 202.

The multipolar magnetic body 20202 is driven so that the coils 208 generate the induced alternating current voltages when the mouse wheel 202 is rotated. The alternating current to direct current conversion circuit 302 converts the induced alternating current voltages of the coils 208 into direct current voltages and then stores the direct current voltages in the energy storing apparatus 304 to supply power to the self-powered wireless mouse apparatus 10.

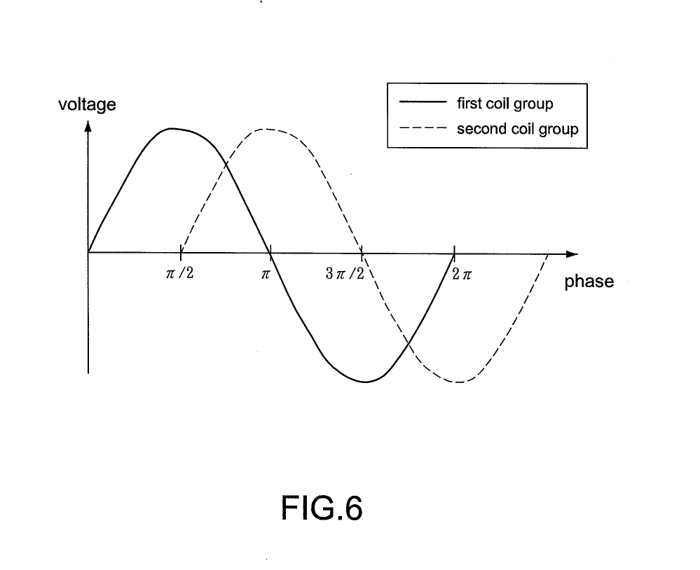

FIG. 6 shows an embodiment of the phase difference of the induced electromotive forces of the coils of the present invention. Please refer to FIG. 1 and FIG. 2 again. A solid line shown in FIG. 6 shows the phase of the induced electromotive forces of the coils 206 arranged on the right stator plate 204 shown in FIG. 1 and FIG. 2 (namely, a first coil group 20602). A dash line shown in FIG. 6 shows the phase of the induced electromotive forces of the coils 206 arranged on the left stator plate 204 shown in FIG. 1 and FIG. 2 (namely, a second coil group 20604).

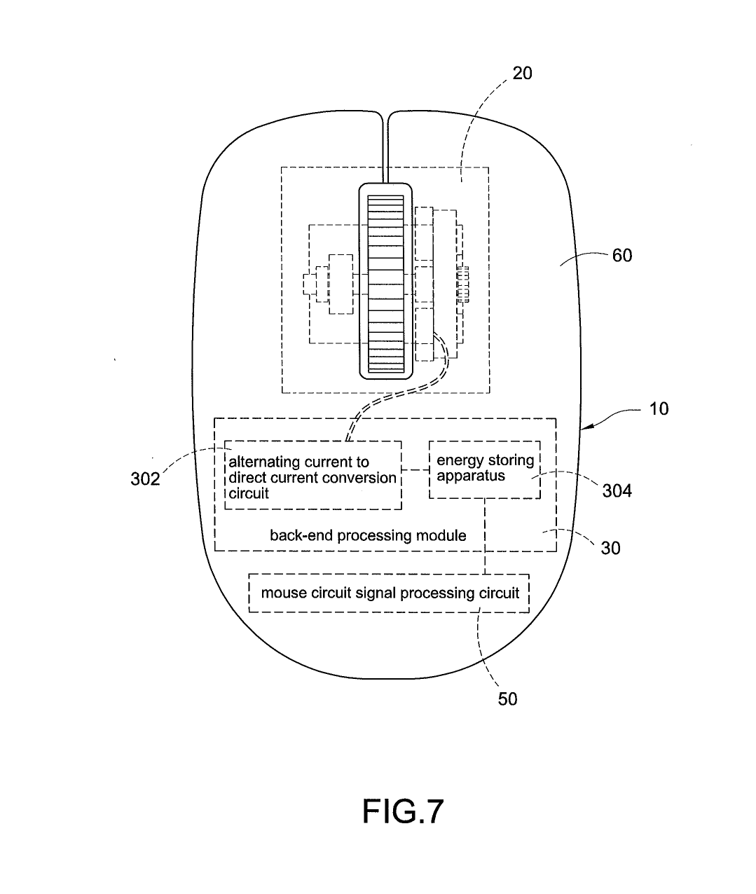

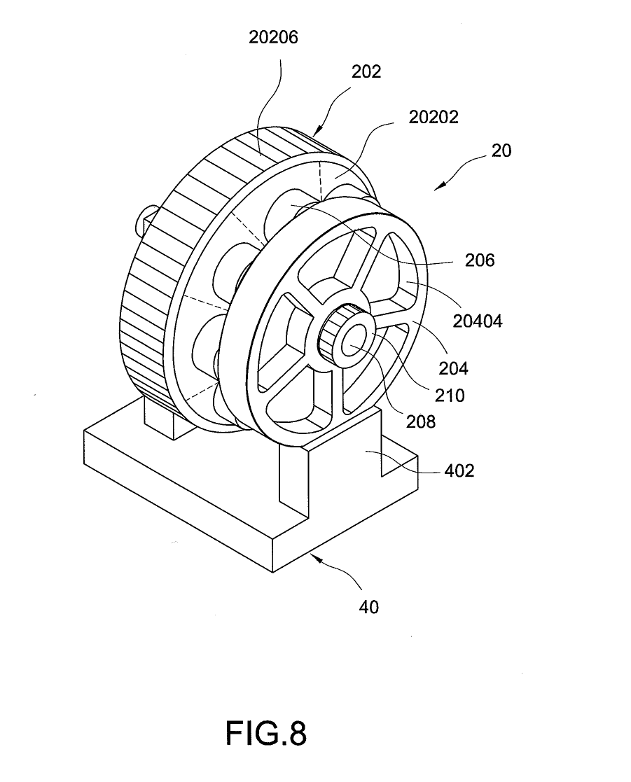

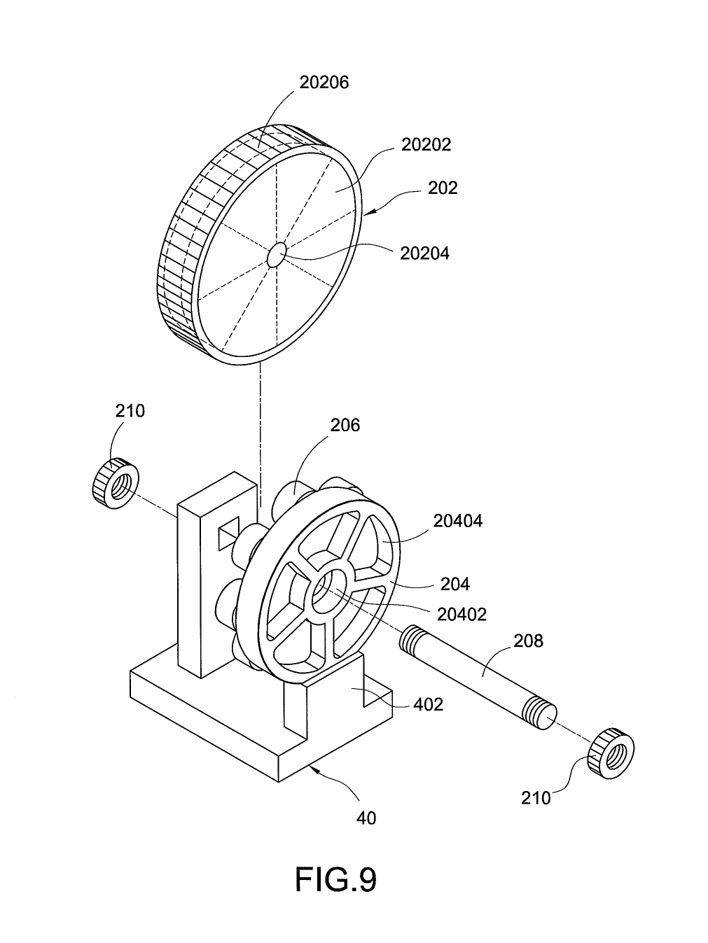

FIG. 7 shows a top view of another embodiment of the self-powered wireless mouse apparatus of the present invention. FIG. 8 shows a partial assembly drawing of another embodiment of the self-powered wireless mouse apparatus of the present invention. FIG. 9 shows a partial exploded view of another embodiment of the self-powered wireless mouse apparatus of the present invention.

The description for the elements shown in FIG. 7 to FIG. 9, which are similar to those shown in figures mentioned above, is not repeated here for brevity.

The advantage of the present invention is to provide a self-powered wireless mouse apparatus.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A self-powered wireless mouse apparatus comprising:
a mouse wheel module; and
a back-end processing module electrically connected to the mouse wheel module,
wherein the mouse wheel module comprises:
a mouse wheel comprising a multipolar magnetic body;
at lease a stator plate;
a plurality of coils arranged on the stator plate; and
a rotation shaft connected to the mouse wheel and the stator plate, the mouse wheel rotated opposite to the stator plate, the coils generating induced alternating current voltages,
wherein the back-end processing module comprises:
an alternating current to direct current conversion circuit electrically connected to the coils; and
an energy storing apparatus electrically connected to the alternating current to direct current conversion circuit,
wherein the multipolar magnetic body is driven so that the coils generate the induced alternating current voltages when the mouse wheel is rotated; the alternating current to direct current conversion circuit converts the induced alternating current voltages of the coils into direct current voltages and then stores the direct current voltages in the energy storing apparatus to supply power to the self-powered wireless mouse apparatus.

2. The self-powered wireless mouse apparatus in claim 1, the self-powered wireless mouse apparatus comprising two stator plates, wherein the mouse wheel is arranged at a midpoint between the stator plates; the stator plates are arranged symmetrically.

3. The self-powered wireless mouse apparatus in claim 2, wherein the mouse wheel further comprises a mouse wheel hole defined at a center of the multipolar magnetic body; the stator plate comprises a stator plate hole defined at a center of the stator plate; the rotation shaft is through the mouse wheel hole and the stator plate holes.

4. The self-powered wireless mouse apparatus in claim 3, wherein the coils are arranged evenly and symmetrically on the stator plates.

5. The self-powered wireless mouse apparatus in claim 4, wherein a quantity of the coils is an integer multiple of a quantity of magnetic poles of the multipolar magnetic body.

6. The self-powered wireless mouse apparatus in claim 5, wherein the multipolar magnetic body is a cylinder.

7. The self-powered wireless mouse apparatus in claim 6, wherein the magnetic poles of the multipolar magnetic body are arranged evenly.

8. The self-powered wireless mouse apparatus in claim 7, wherein the coils face the mouse wheel.

9. The self-powered wireless mouse apparatus in claim 8, further comprising a mouse base, wherein the stator plates are arranged on the mouse base.

10. The self-powered wireless mouse apparatus in claim 9, wherein the mouse base comprises two support columns for supporting the stator plates.
